(19) United States
(12) Patent Application Publication
(10) Pub. No.: US 2022/0329813 A1
(43) Pub. Date: Oct. 13, 2022

(54) DEVICE AND METHOD FOR CODING VIDEO DATA

(71) Applicant: FG Innovation Company Limited, Tuen Mun (HK)

(72) Inventors: CHIH-YU TENG, Taipei (TW); YU-CHIAO YANG, Taipei (TW)

(21) Appl. No.: 17/714,463

(22) Filed: Apr. 6, 2022

Related U.S. Application Data
(60) Provisional application No. 63/173,954, filed on Apr. 12, 2021.

(51) Int. Cl. H04N 19/132; H04N 19/176; H04N 19/159; H04N 19/50; H04N 19/105; H04N 19/167; H04N 19/463

(52) U.S. Cl. CPC H04N 19/132; H04N 19/176; H04N 19/159; H04N 19/50; H04N 19/105; H04N 19/167; H04N 19/463

(57) ABSTRACT

A method of decoding a bitstream by an electronic device is provided. The electronic device receives the bitstream. In addition, the electronic device determines a block unit from an image frame according to the bitstream and determines a linear model prediction mode of the block unit based on a plurality of linear mode candidates. The plurality of linear mode candidates is used to derive a plurality of linear model formulas based on a plurality of sample sets determined from a common reference region. The electronic device further reconstructs the block unit based on the linear model prediction mode

### CROSS-REFERENCE TO RELATED APPLICATION(S)

The present disclosure claims the benefit of and priority to U.S. Provisional Patent Application Ser. No. 63/173,954, filed on Apr. 12, 2021, entitled “Proposed linear model derivation in CCLM,” the content of which is hereby incorporated fully by reference into the present disclosure.

### FIELD

The present disclosure is generally related to video coding, and more specifically, to techniques for using different sample sets in linear model prediction.

### BACKGROUND

Linear model prediction is a coding tool for video coding. In a conventional video coding method, an encoder and a decoder only use the previously reconstructed pixels adjacent to the block unit and in one predefined reference region to generate a linear model for predicting or reconstructing a plurality of chroma pixels of the coding block based on a plurality of luma reconstructed pixels of the block unit.

However, the one predefined reference region and the linear model may be inadequate to predict all of the block units in the video. In addition, the decoding efficiency may be low when the linear model is derived based on all of the previously reconstructed pixels in the predefined reference region. Therefore, the encoder and the decoder may need different sample sets generated by different sampling methods for predicting or reconstructing the chroma pixels.

### SUMMARY

The present disclosure is directed to a device and method for predicting a block unit in an image frame by using a plurality of linear mode candidates having different sample sets.

In a first aspect of the present disclosure, a method of decoding a bitstream and an electronic device for performing the method are provided. The method comprises determining a block unit from an image frame according to the bitstream; determining a linear model prediction mode of the block unit based on a plurality of linear mode candidates, the plurality of linear mode candidates being used to derive a plurality of linear model formulas based on a plurality of sample sets determined from a common reference region; and reconstructing the block unit based on the linear model prediction mode.

In another implementation of the first aspect, the plurality of sample sets is determined from the common reference region based on a plurality of sampling schemes; the sample sets in the plurality of sample sets are different from each other; and the sampling schemes in the plurality of sampling schemes are different from each other.

In another implementation of the first aspect, the common reference region includes a plurality of candidate samples; a specific one of the plurality of linear mode candidates selects a plurality of reference samples from the plurality of candidate samples into a specific one of the plurality of sample sets based on a specific one of a plurality of sampling schemes; and the specific one of the plurality of sample sets and the specific one of the plurality of sampling schemes correspond to the specific one of the plurality of linear mode candidates.

In another implementation of the first aspect, each of the plurality of sampling schemes includes a starting parameter and an interval parameter.

In another implementation of the first aspect, the linear model prediction mode includes two of the plurality of linear mode candidates; and the block unit is reconstructed based on the two of the plurality of linear mode candidates.

In another implementation of the first aspect, a first one of the two of the plurality of linear mode candidates derives a first one of the plurality of linear model formulas based on a first one of the plurality of sample sets determined from the common reference region; and a second one of the two of the plurality of linear mode candidates derives a second one of the plurality of linear model formulas based on a second one of the plurality of sample sets determined from the common reference region.

In another implementation of the first aspect, a first plurality of reference samples is selected from the common reference region for a first one of the two of the plurality of linear mode candidates based on a first sampling scheme; and a second plurality of reference samples is selected from the common reference region for a second one of the two of the plurality of linear mode candidates based on a second sampling scheme.

In another implementation of the first aspect, the first sampling scheme includes a first starting parameter and a first interval parameter; the second sampling scheme includes a second starting parameter and a second interval parameter; the first interval parameter is different from the second interval parameter when the first starting parameter is identical to the second starting parameter; and the first starting parameter is different from the second starting parameter when the first interval parameter is identical to the second interval parameter.

In another implementation of the first aspect, each of the first plurality of reference samples is different from each of the second plurality of reference samples.

In a second aspect of the present disclosure, a method for decoding a bitstream and an electronic device for performing the method are provided. The method comprises receiving the bitstream; determining a block unit from an image frame according to the bitstream; determining a linear model prediction mode of the block unit based on a plurality of linear mode candidates having a common reference region, wherein: the plurality of linear mode candidates is used to derive a plurality of linear model formulas based on the common reference region, and the linear model formulas in the plurality of linear model formulas are different from each other; and reconstructing the block unit based on the linear model prediction mode.

In another implementation of the second aspect, each of the plurality of linear mode candidates corresponds to one of a plurality of sample sets; the plurality of sample sets is determined from the common reference region based on a plurality of sampling schemes; the sample sets in the plurality of sample sets are different from each other; and the sampling schemes in the plurality of sampling schemes are different from each other.

In another implementation of the second aspect, the common reference region includes a plurality of candidate samples; a specific one of the plurality of linear mode candidates selects a plurality of reference samples from the plurality of candidate samples into a specific one of the plurality of sample sets based on a specific one of a plurality of sampling schemes; and the specific one of the plurality of sample sets and the specific one of the plurality of sampling schemes correspond to the specific one of the plurality of linear mode candidates.

In another implementation of the second aspect, the linear model prediction mode includes two of the plurality of linear mode candidates; and the block unit is reconstructed based on the two of the plurality of linear mode candidates.

In another implementation of the second aspect, a first plurality of reference samples is selected from the common reference region for a first one of the two of the plurality of linear mode candidates based on a first sampling scheme; and a second plurality of reference samples is different from the first plurality of reference samples and selected from the common reference region for a second one of the two of the plurality of linear mode candidates based on a second sampling scheme.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 illustrates a block diagram of a system configured to encode and decode video data according to an implementation of the present disclosure.

FIG. 2 illustrates a block diagram of the decoder module of the second electronic device illustrated in FIG. 1 according to an implementation of the present disclosure.

FIG. 3 illustrates a flowchart of a method for decoding video data by an electronic device according to an implementation of the present disclosure.

FIG. 4A and FIG. 4B are schematic illustrations of an example implementation of a reference region of a linear mode candidate for a block unit.

FIGS. 5A-5C are schematic illustrations of example implementations of chroma block units, the chroma adjacent regions, and a plurality of chroma extending regions for three linear mode candidates.

FIG. 6 illustrates a flowchart of a method for decoding video data by an electronic device according to an implementation of the present disclosure.

FIG. 7A and FIG. 7B are schematic illustrations of an example implementation of a common reference region of linear mode candidates for a block unit.

FIGS. 8A-8D are schematic illustrations of example implementations of a chroma block unit and four different sample sets included in the common reference region.

FIG. 9 illustrates a flowchart of a method for decoding video data by an electronic device according to an implementation of the present disclosure.

FIG. 10 illustrates a block diagram of the encoder module of the first electronic device illustrated in FIG. 1 according to an implementation of the present disclosure.

### DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purpose of consistency and ease of understanding, like features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” may refer to one or more of the same or different implementations. The term “coupled” is defined as connected, whether directly or indirectly, through intervening components and is not necessarily limited to physical connections. The term “comprising” means “including, but not necessarily limited to” and specifically indicates open-ended inclusion or membership in the so-described combination, group, series and the equivalent.

For purposes of explanation and non-limitation, specific details such as functional entities, techniques, protocols, and standards are set forth for providing an understanding of the disclosed technology. Detailed disclosure of well-known methods, technologies, systems and architectures are omitted so as not to obscure the present disclosure with unnecessary details.

Persons skilled in the art will recognize that any disclosed coding function(s) or algorithm(s) described in the present disclosure may be implemented by hardware, software or a combination of software and hardware. Disclosed functions may correspond to modules that are software, hardware, firmware, or any combination thereof.

A software implementation may include a program having computer executable instructions stored on computer readable medium such as memory or other type of storage devices. For example, one or more microprocessors or general-purpose computers with communication processing capability may be programmed with executable instructions and perform the disclosed function(s) or algorithm(s).

The microprocessors or general-purpose computers may be formed of application-specific integrated circuits (ASICs), programmable logic arrays, and/or using one or more digital signal processors (DSPs). Although some of the disclosed implementations are oriented to software installed and executing on computer hardware, alternative implementations implemented as firmware or as hardware or combination of hardware and software are well within the scope of the present disclosure. The computer readable medium includes but is not limited to random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-readable instructions.

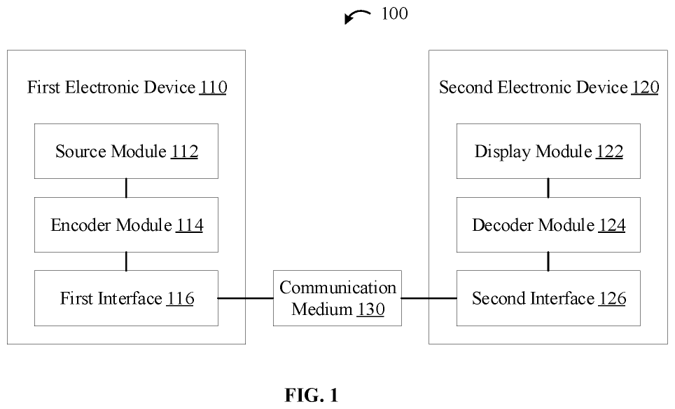

FIG. 1 illustrates a block diagram of a system 100 configured to encode and decode video data according to an implementation of the present disclosure. The system 100 includes a first electronic device 110, a second electronic device 120, and a communication medium 130.

The first electronic device 110 may be a source device including any device configured to encode video data and transmit encoded video data to the communication medium 130. The second electronic device 120 may be a destination device including any device configured to receive encoded video data via the communication medium 130 and decode encoded video data.

The first electronic device 110 may communicate via wire or wirelessly with the second electronic device 120 via the communication medium 130. The first electronic device 110 may include a source module 112, an encoder module 114, and a first interface 116. The second electronic device 120 may include a display module 122, a decoder module 124, and a second interface 126. The first electronic device 110 may be a video encoder and the second electronic device 120 may be a video decoder.

The first electronic device 110 and/or the second electronic device 120 may be a mobile phone, a tablet, a desktop, a notebook, or other electronic device. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive video from a video content provider. The source module 112 may generate computer graphics-based data as the source video or generate a combination of live video, archived video, and computer-generated video as the source video. The video capture device may be a charge-coupled device (CCD) image sensor, a complementary metal-oxide-semiconductor (CMOS) image sensor, or a camera.

The encoder module 114 and the decoder module 124 may each be implemented as any of a variety of suitable encoder/decoder circuitry such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware or any combinations thereof. When implemented partially in software, a device may store the program having instructions for the software in a suitable, non-transitory computer-readable medium and execute the instructions in hardware using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, Wireless USB or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE) or Time-Division LTE (TD-LTE). The first interface 116 and the second interface 126 may each include any device configured to transmit and/or store a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure that may be used to interconnect peer devices.

The display module 122 may include a display using liquid crystal display (LCD) technology, plasma display technology, organic light emitting diode (OLED) display technology, or light-emitting polymer display (LPD) technology, with other display technologies used in other implementations. The display module 122 may include a high-definition display or an ultra-high-definition display.

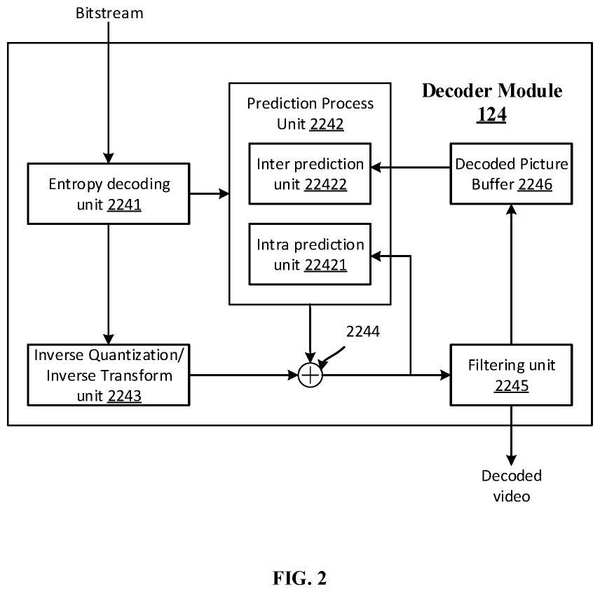

FIG. 2 illustrates a block diagram of the decoder module 124 of the second electronic device 120 illustrated in FIG. 1 according to an implementation of the present disclosure. The decoder module 124 includes an entropy decoder (e.g., entropy decoding unit 2241), a prediction processor (e.g., prediction process unit 2242), an inverse quantization/inverse transform processor (e.g., inverse quantization/inverse transform unit 2243), a summer (e.g., summer 2244), a filter (e.g., filtering unit 2245), and a decoded picture buffer (e.g., decoded picture buffer 2246). The prediction process unit 2242 further includes an intra prediction processor (e.g., intra prediction unit 22421) and an inter prediction processor (e.g., inter prediction unit 22422). The decoder module 124 receives a bitstream and decodes the bitstream to output decoded video.

The entropy decoding unit 2241 may receive the bitstream including a plurality of syntax elements from the second interface 126 in FIG. 1 and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and other syntax information.

The entropy decoding unit 2241 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction process unit 2242.

The prediction process unit 2242 may receive syntax elements such as motion vectors, intra modes, partition information, and other syntax information from the entropy decoding unit 2241. The prediction process unit 2242 may receive the syntax elements including the partition information and divide image frames according to the partition information.

Each of the image frames may be divided into at least one image block according to the partition information. The at least one image block may include a luminance block for reconstructing a plurality of luminance samples and at least one chrominance block for reconstructing a plurality of chrominance samples. The luminance block and the at least one chrominance block may be further divided to generate macroblocks, coding tree units (CTUs), coding blocks (CBs), sub-divisions thereof, and/or another equivalent coding unit.

During the decoding process, the prediction process unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct a plurality of chroma components of the current block unit based on a plurality of luma components of the current block unit when the chroma components are reconstructed by the prediction process unit 2242.

The intra prediction unit 22421 may reconstruct a plurality of chroma components of the current block unit based on the plurality of luma components of the current block unit when the luma components of the current block are reconstructed by the prediction process unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit is a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process such as discrete cosine transform (DCT), discrete sine transform (DST), adaptive multiple transform (AMT), mode-dependent non-separable secondary transform (MDNSST), Hypercube-Givens transform (HyGT), signal-dependent transform, Karhunen-Loéve transform (KLT), wavelet transform, integer transform, sub-band transform or a conceptually similar transform. The inverse transformation may convert the residual information from a transform domain, such as a frequency domain, back to the pixel domain. The degree of inverse quantization may be modified by adjusting a quantization parameter.

The summer 2244 adds the reconstructed residual block to the predicted block provided from the prediction process unit 2242 to produce a reconstructed block.

The filtering unit 2245 may include a deblocking filter, a sample adaptive offset (SAO) filter, a bilateral filter, and/or an adaptive loop filter (ALF) to remove blocking artifacts from the reconstructed block. Additional filters (in loop or post loop) may also be used in addition to the deblocking filter, the SAO filter, the bilateral filter and the ALF. Such filters are not explicitly illustrated for brevity but may filter the output of the summer 2244. The filtering unit 2245 may output the decoded video to the display module 122 or other video receiving unit after the filtering unit 2245 performs the filtering process for the reconstructed blocks of the specific image frame.

The decoded picture buffer 2246 may be a reference picture memory that stores the reference block for use by the prediction process unit 2242 in decoding the bitstream (in inter coding modes). The decoded picture buffer 2246 may be formed by any of a variety of memory devices such as dynamic random-access memory (DRAM), including synchronous DRAM (SDRAM), magneto-resistive RAM (MRAM), resistive RAM (RRAM), or other types of memory devices. The decoded picture buffer 2246 may be on-chip with other components of the decoder module 124 or off-chip relative to those components.

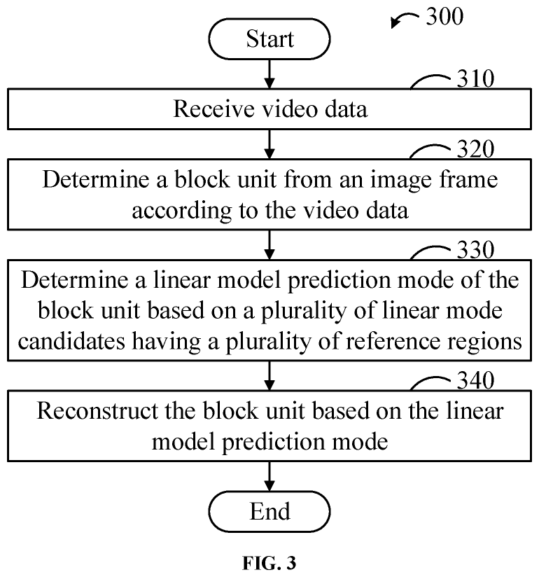

FIG. 3 illustrates a flowchart of a method 300 for decoding video data by an electronic device according to an implementation of the present disclosure. The method 300 is an example only, as there are a variety of ways to perform decoding of the video data.

The method 300 may be performed using the configurations illustrated in FIG. 1 and FIG. 2, and various elements of these figures are referenced with regard to the method 300. Each block illustrated in FIG. 3 may represent one or more processes, methods, or subroutines performed.

The order of blocks in FIG. 3 is illustrative only and may change. Additional blocks may be added or fewer blocks may be utilized without departing from the present disclosure.

At block 310, the decoder module 124 receives video data. The video data received by the decoder module 124 may be a bitstream.

With reference to FIG. 1 and FIG. 2, the second electronic device 120 may receive the bitstream from an encoder, such as the first electronic device 110, or other video providers via the second interface 126. The second interface 126 may provide the bitstream to the decoder module 124.

The entropy decoding unit 2241 may decode the bitstream to determine a plurality of prediction indications and a plurality of partitioning indications for a plurality of image frames. Then, the decoder module 124 may further reconstruct the plurality of image frames based on the prediction indications and the partitioning indications. The prediction indications and the partitioning indications may include a plurality of flags and a plurality of indices.

At block 320, the decoder module 124 determines a block unit from an image frame according to the video data.

With reference to FIG. 1 and FIG. 2, the decoder module 124 may determine the image frame based on the bitstream and divide the image frame to determine the block unit according to the partition indications in the bitstream. For example, the decoder module 124 may divide the image frames to generate a plurality of CTUs, and further divide one of the CTUs to determine the block unit according to the partition indications based on any video coding standard.

Continuing with FIG. 3, at block 330, the decoder module 124 determines a linear model prediction mode of the block unit based on a plurality of linear mode candidates having a plurality of reference regions.

With reference to FIG. 1 and FIG. 2, the linear mode candidates may be used to derive a plurality of linear model formulas based on a cross-component linear model (CCLM) prediction mode and/or a multiple directional linear model (MDLM) prediction mode. The decoder module 124 may use the linear model prediction mode to derive one linear model formula to predict the block unit when the linear model formula of the linear model prediction mode is derived based on the CCLM prediction mode or the MDLM prediction mode. The decoder module 124 may determine the linear model prediction mode of the block unit via a mode index included in the bitstream.

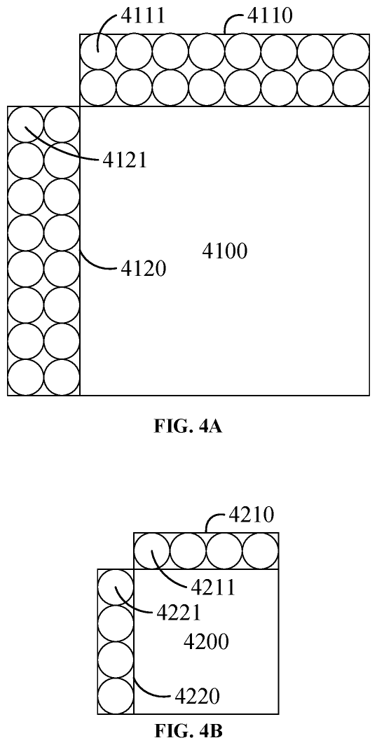

FIG. 4A and FIG. 4B are schematic illustrations of an example implementation of a reference region of a specific one of the linear mode candidates for a block unit. The block unit may include a luma block unit and a chroma block unit. FIG. 4A is a schematic illustration of an example implementation of a luma block unit 4100 and a plurality of luma adjacent regions 4110 and 4120. There may be a plurality of luma candidate samples in the luma adjacent regions 4110 and 4120. For example, a luma candidate sample 4111 may be included in the luma adjacent region 4110 and a luma candidate sample 4121 may be included in the luma adjacent region 4120. Each of the luma candidate samples may be included in a luma adjacent block adjacent to the luma block unit 4100. In addition, the luma adjacent blocks may be reconstructed prior to reconstructing the luma block unit 4100. Thus, each of the luma candidate samples may be a luma reconstructed sample included in the luma adjacent block and reconstructed based on the bitstream.

FIG. 4B is a schematic illustration of an example implementation of a chroma block unit 4200 and a plurality of chroma adjacent regions 4210 and 4220. There may be a plurality of chroma candidate samples in the chroma adjacent regions 4210 and 4220. For example, a chroma candidate sample 4211 may be included in the chroma adjacent region 4210 and a chroma candidate sample 4221 may be included in the chroma adjacent region 4220. Each of the chroma candidate samples may be included in a chroma adjacent block adjacent to the chroma block unit 4200. In addition, the chroma adjacent blocks may be reconstructed prior to reconstructing the chroma block unit 4200. Thus, each of the chroma candidate samples may be a chroma reconstructed sample included in the chroma adjacent block and reconstructed based on the bitstream. In FIG. 4A and FIG. 4B, the reference region of the specific linear mode candidate may include the luma adjacent regions 4110 and 4120 and the chroma adjacent regions 4210 and 4220.

The size of the luma block unit 4100 may be greater than the size of the chroma block unit 4200 due to chroma subsampling. Thus, before at least one linear model formula is derived based on the luma candidate samples and the chroma candidate samples, the luma candidate samples may be down-sampled to generate a plurality of luma down-sampled samples according to a sampling format of the block unit. The sampling format may include 4:4:4, 4:2:2, 4:2:0, and other sampling strategies. In FIG. 4A, the luma candidate samples in the luma adjacent regions 4110 and 4120 may be down-sampled to generate the luma down-sampled samples based on the sampling format 4:2:0 to correspond to the chroma candidate samples in the chroma adjacent regions 4210 and 4220.

In order to predict the chroma block unit 4200, in one of the linear mode candidates, the chroma adjacent region 4220 may be moved to be located to the right of the chroma adjacent region 4210. However, in the one of the linear mode candidates, there may be no reference sample located to the left of the chroma block unit 4200. In addition, in another one of the linear mode candidates, the chroma adjacent region 4210 may be moved to be located below the chroma adjacent region 4220. However, in the one of the linear mode candidates, there may be no reference sample located above the chroma block unit 4200. In these two linear mode candidates, the derivation for predicting the chroma block unit 4200 may lose some information generated from one of an above chroma adjacent block and a left chroma adjacent block.

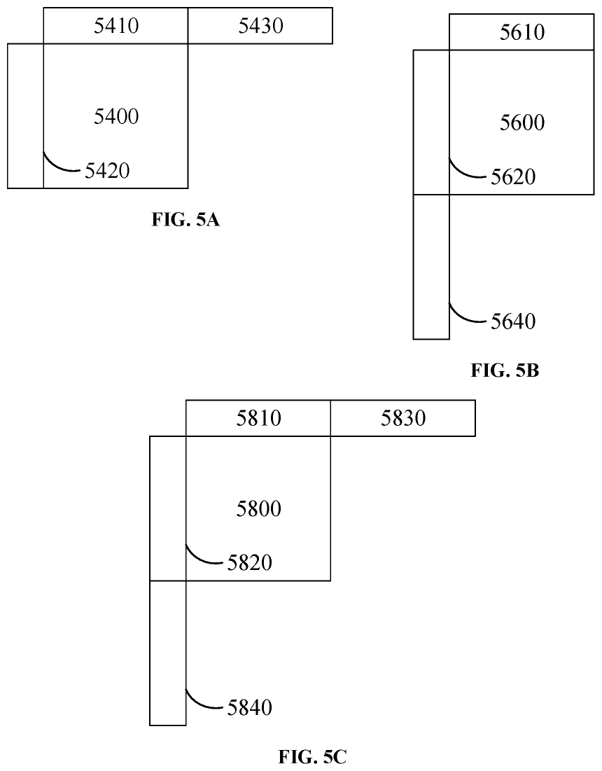

FIGS. 5A-5C are schematic illustrations of example implementations of chroma block units 5400, 5600, and 5800, the chroma adjacent regions, and a plurality of chroma extending regions for three linear mode candidates. In FIG. 5A, the chroma adjacent regions 5410 and 5420 and a chroma extending region 5430 may be included in the reference region of a first one of the three linear mode candidates for predicting the chroma block unit 5400. In FIG. 5B, the chroma adjacent regions 5610 and 5620 and a chroma extending region 5640 may be included in the reference region of a second one of the three linear mode candidates for predicting the chroma block unit 5600. In FIG. 5C, the chroma adjacent regions 5810 and 5820 and two chroma extending regions 5830 and 5840 may be included in the reference region of a third one of the three linear mode candidates for predicting the chroma block unit 5800. The chroma adjacent regions 5410, 5610, and 5810 may be located above the chroma block unit. The chroma adjacent regions 5420, 5620, and 5820 may be located to the left of the chroma block unit. The chroma extending regions 5430 and 5830 may be located to the top-right of the chroma block unit. The chroma extending regions 5640 and 5840 may be located to the left-below of the chroma block unit. In the implementation, the luma block unit may have the luma adjacent regions each corresponding to one of the chroma adjacent regions and at least one luma extending region each corresponding to one of at least one chroma extending region.

The chroma extending regions 5430 and 5830 may be extended from the chroma adjacent regions 5410 and 5810 along a first extension direction, and the chroma extending regions 5640 and 5840 may be extended from the chroma adjacent regions 5620 and 5820 along a second extension direction. The first extension direction may be different from the second extension direction. The number of the chroma extending regions extending along the first extension direction may be greater than or less than the number of the chroma extending regions extending along the second extension direction. In one implementation, the first extension direction may be a right direction, and the second extension direction may be a down direction.

In some of the linear mode candidates, the number of the chroma extending regions extending along the first extension direction may be greater than the number of the chroma extending regions extending along the second extension direction. For example, in FIG. 5A, the number of the chroma extending regions extending along the first extension direction is equal to one and the number of the chroma extending regions extending along the second extension direction is equal to zero. In addition, the number of the chroma candidate samples located to the left of the chroma block unit may be greater than zero and less than the number of the chroma candidate samples above the chroma block unit since the chroma adjacent region located to the left of the chroma block unit is not moved. Thus, the number of the chroma candidate samples above the chroma block unit may be increased without losing the candidate samples located to the left of the chroma block unit. Therefore, the derivation for predicting the chroma block unit may enhance the reference information extracted from the above adjacent block without losing the reference information extracted from the left adjacent block.

In some other linear mode candidates, the number of the chroma extending regions extending along the first extension direction may be less than the number of the chroma extending regions extending along the second extension direction. For example, in FIG. 5B, the number of the chroma extending regions extending along the first extension direction is equal to zero and the number of the chroma extending regions extending along the second extension direction is equal to one. In addition, the number of the chroma candidate samples above the chroma block unit may also be greater than zero and less than the number of the chroma candidate samples located to the left of the chroma block unit since the chroma adjacent region located above the chroma block unit is not moved. Thus, the number of the chroma candidate samples located to the left of the chroma block unit may be increased without losing the candidate samples above the chroma block unit. Therefore, the derivation for predicting the chroma block unit may enhance the reference information extracted from the left adjacent block without losing the reference information extracted from the above adjacent block.

There may be at least one luma extending region each corresponding to one of the chroma extending regions. When there are two chroma extending regions used to predict the chroma block unit, there may also two corresponding luma extending regions used to predict the chroma block unit. When there is only one chroma extending region used to predict the chroma block unit, there may also one corresponding luma extending region used to predict the chroma block unit.

Returning to FIG. 3, at block 340, the decoder module 124 reconstructs the block unit based on the linear model prediction mode.

With reference to FIG. 1, FIG. 2, FIG. 4A, and FIG. 4B, the linear model prediction mode may be selected from the linear mode candidates. The selected linear mode candidate may have a corresponding one of the reference regions. Thus, the decoder module 124 may determine the corresponding one of the reference regions based on the selected linear mode candidate and further determine the candidate samples included in the corresponding one of the reference regions. In addition, the decoder module 124 may down-sample the luma candidate samples to generate the luma down-sampled samples.

The decoder module 124 may select all of the luma down-sampled samples and chroma candidate samples included in the corresponding one of the reference regions as a plurality of reference samples for deriving the linear model formula. In another implementation, the decoder module 124 may select a part of the luma down-sampled samples and chroma candidate samples included in the corresponding one of the reference regions based on a sampling method as the reference samples for deriving the linear model formula. The sampling method may include but is not limited to the sampling schemes in the present disclosure.

The decoder module 124 may derive the linear model formula for the block unit by the following equation (1):

pred_{C}(i,j)=α·rec_{L}′(i,j)+β (1)

where pred_{C}(i, j) represents one of a plurality of chroma predicted components in the chroma block unit 4200, rec_{L}′(i, j) represents one of a plurality of luma down-sampled components in the luma block unit 4100, and α and β represent a predicted parameter and a constant parameter derived based on the reference samples. The luma down-sampled components may be generated by down-sampling a plurality of luma reconstructed components in the luma block unit 4100. The chroma predicted components may be generated based on the luma down-sampled components according to the linear model formula since the luma reconstructed components are reconstructed prior to generating the chroma predicted components.

The decoder module 124 may derive the predicted parameter α and the constant parameter β based on the reference samples when the decoder module 124 may generate the chroma predicted components of the chroma block unit 4200 based on the luma down-sampled components of the luma block unit 4100. The decoder module 124 may estimate the predicted parameter a and the constant parameter β based on the reference samples via a statistical method. In at least one implementation, the statistical method may be a linear regression analysis. In at least one implementation, the two parameters α and β may be derived by the following equation (2):

$$α = \frac{N \cdot Σ ( L ( n ) \cdot C ( n ) ) - Σ L ( n ) \cdot Σ C ( n )}{N \cdot Σ ( L ( n ) \cdot L ( n ) ) - Σ L ( n ) \cdot Σ L ( n )} β = \frac{Σ C ( n ) - α \cdot Σ L ( n )}{N} \qquad ( 2 )$$

wherein L(n) represents the luma down-sampled samples, C(n) represents the chroma candidate samples, and the value of N may be equal to twice the minimum of width and height of the chroma block unit. In another implementation, the decoder module 124 may estimate the predicted parameter α and the constant parameter β based on a part or all of the chroma candidate samples and the luma down-sampled samples via other derivation methods. For example, the predicted parameter α and the constant parameter β may be derived based on two of the luma down-sampled samples and two of the chroma candidate samples. In the implementation, the two of the luma down-sampled samples have a first maximum sample value and a first minimum sample value determined from the luma down-sampled samples, and the two of the chroma candidate samples are co-located with the two of the luma down-sampled samples.

The decoder module 124 may select a first part of the luma down-sampled samples and chroma candidate samples included in the corresponding one of the reference regions based on a first sampling method as first reference samples for deriving a first linear model formula and select a second part of the luma down-sampled samples and chroma candidate samples included in the corresponding one of the reference regions based on a second sampling method as second reference samples for deriving a second linear model formula. Thus, the decoder module 124 may generate two predicted parameters α1 and α2 and two constant parameters β1 and β2 respectively based on the first reference samples and the second reference samples. The first sampling method and the second sampling method may be identical to or different from each other.

The chroma predicted components may be generated based on the luma down-sampled components according to the at least one linear model formula, since the luma reconstructed components are reconstructed prior to generating the chroma predicted components. The decoder module 124 may directly down-sample the luma reconstructed components of the luma block unit to generate the luma down-sampled samples and then determine the chroma predicted components based on the luma down-sampled components according to the at least one linear model formula.

The chroma block unit may include a plurality of chroma block elements. In the implementation, each of the chroma block elements may be a chroma pixel element. The decoder module 124 may generate one of the chroma predicted components for each of the block elements. In at least one implementation, the summer 2244 of the decoder module 124 in the second electronic device 120 may add the chroma predicted components into a plurality of chroma residual samples determined from the bitstream to reconstruct the chroma block unit of the block unit. In addition, the decoder module 124 may reconstruct all of the other block units in the image frame for reconstructing the image frame and the video.

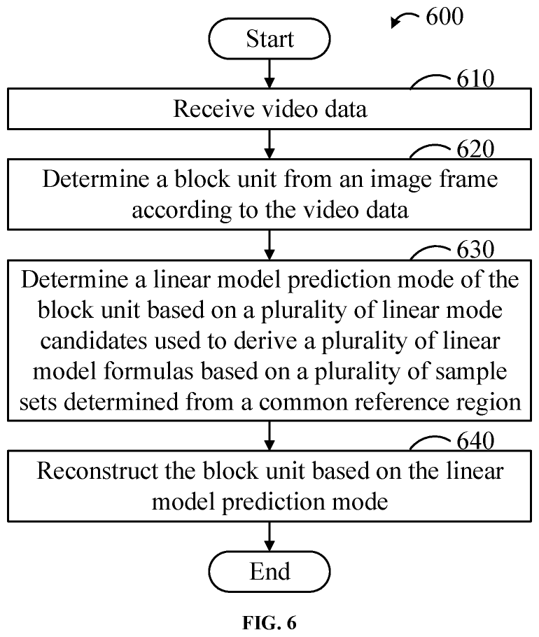

FIG. 6 illustrates a flowchart of a method 600 for decoding video data by an electronic device according to an implementation of the present disclosure. The method 600 is an example only, as there are a variety of ways to perform decoding of the video data.

The method 600 may be performed using the configurations illustrated in FIG. 1 and FIG. 2, and various elements of these figures are referenced with regard to the method 600. Each block illustrated in FIG. 6 may represent one or more processes, methods, or subroutines performed.

The order of blocks in FIG. 6 is illustrative only and may change. Additional blocks may be added or fewer blocks may be utilized without departing from the present disclosure.

At block 610, the decoder module 124 receives video data. The video data received by the decoder module 124 may be a bitstream.

With reference to FIG. 1 and FIG. 2, the second electronic device 120 may receive the bitstream from an encoder, such as the first electronic device 110, or other video providers via the second interface 126. The second interface 126 may provide the bitstream to the decoder module 124.

The entropy decoding unit 2241 may decode the bitstream to determine a plurality of prediction indications and a plurality of partitioning indications for a plurality of image frames. Then, the decoder module 124 may further reconstruct the plurality of image frames based on the prediction indications and the partitioning indications. The prediction indications and the partitioning indications may include a plurality of flags and a plurality of indices.

At block 620, the decoder module 124 determines a block unit from an image frame according to the video data.

With reference to FIG. 1 and FIG. 2, the decoder module 124 may determine the image frame based on the bitstream and divide the image frame to determine the block unit according to the partition indications in the bitstream. For example, the decoder module 124 may divide the image frames to generate a plurality of CTUs, and further divide one of the CTUs to determine the block unit according to the partition indications based on any video coding standard.

Continuing with FIG. 6, at block 630, the decoder module 124 determines a linear model prediction mode of the block unit based on a plurality of linear mode candidates used to derive a plurality of linear model formulas based on a plurality of sample sets determined from a common reference region

With reference to FIG. 1 and FIG. 2, the linear mode candidates may be used to derive a plurality of linear model formulas based on a CCLM prediction mode and/or a MDLM prediction mode. The decoder module 124 may use the linear model prediction mode to derive one linear model formula to predict the block unit, when the linear model formula of the linear model prediction mode is derived based on the CCLM prediction mode or the MDLM prediction mode. The decoder module 124 may determine the linear model prediction mode of the block unit via a mode index included in the bitstream.

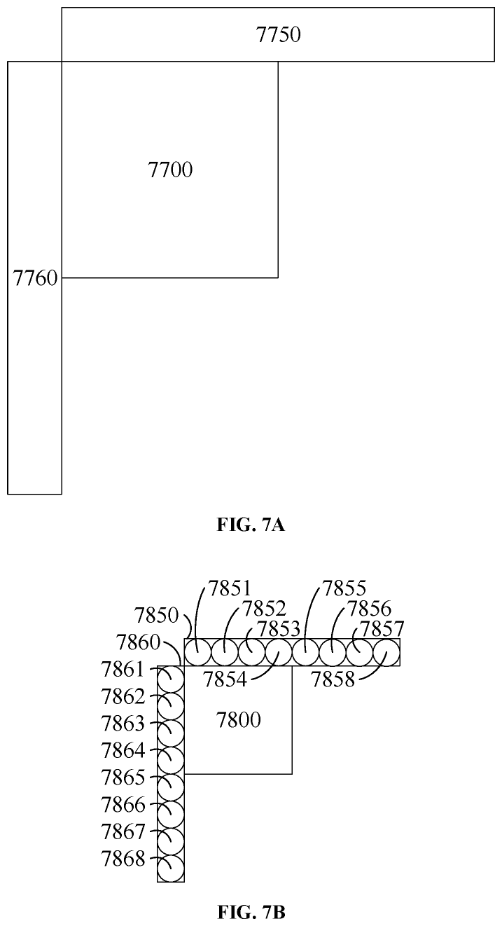

FIG. 7A and FIG. 7B are schematic illustrations of an example implementation of a common reference region of the linear mode candidates for a block unit. The block unit may include a luma block unit and a chroma block unit. FIG. 7A is a schematic illustration of an example implementation of a luma block unit 7700 and a plurality of luma neighboring regions 7750 and 7760. There may be a plurality of luma candidate samples in the luma neighboring regions 7750 and 7760. Each of the luma candidate samples may be included in a luma neighboring block neighboring the luma block unit 7700. In addition, the luma neighboring blocks may be reconstructed prior to reconstructing the luma block unit 7700. Thus, each of the luma candidate samples may be a luma reconstructed sample included in the luma neighboring block and reconstructed based on the bitstream.

FIG. 7B is a schematic illustration of an example implementation of a chroma block unit 7800 and a plurality of chroma neighboring regions 7850 and 7860. There may be a plurality of chroma candidate samples in the chroma neighboring regions 7850 and 7860. For example, the chroma candidate samples 7851-7858 may be included in the chroma neighboring region 7850 and the chroma candidate samples 7861-7868 may be included in the chroma neighboring region 7860. Each of the chroma candidate samples may be included in a chroma neighboring block neighboring the chroma block unit 7800. In addition, the chroma neighboring blocks may be reconstructed prior to reconstructing the chroma block unit 7800. Thus, each of the chroma candidate samples may be a chroma reconstructed sample included in the chroma neighboring block and reconstructed based on the bitstream.

In FIG. 7A and FIG. 7B, the common reference region of the linear mode candidates may include the luma neighboring regions 7750 and 7760 and the chroma neighboring regions 7850 and 7860. In addition, the common reference region of the linear mode candidates may include a plurality of candidate samples including the luma candidate samples in the luma neighboring regions 7750 and 7760 and the chroma candidate samples 7851-7858 and 7561-7868 in the chroma neighboring regions 7850 and 7860. In one implementation, the reference regions of the linear mode candidates may be identical to each other, so each of the reference regions of the linear mode candidates may be identical to the common reference region.

The size of the luma block unit 7700 may be greater than the size of the chroma block unit 7800 due to chroma subsampling. Thus, before at least one linear model formula is derived based on the luma candidate samples and the chroma candidate samples, the luma candidate samples may be down-sampled to generate a plurality of luma down-sampled samples according to a sampling format of the block unit. The sampling format may include 4:4:4, 4:2:2, 4:2:0, and other sampling strategies. In FIG. 7A, the luma candidate samples in the luma neighboring regions 7750 and 7760 may be down-sampled to generate the luma down-sampled samples based on the sampling format 4:2:0 to correspond to the chroma candidate samples in the chroma neighboring regions 7850 and 7860.

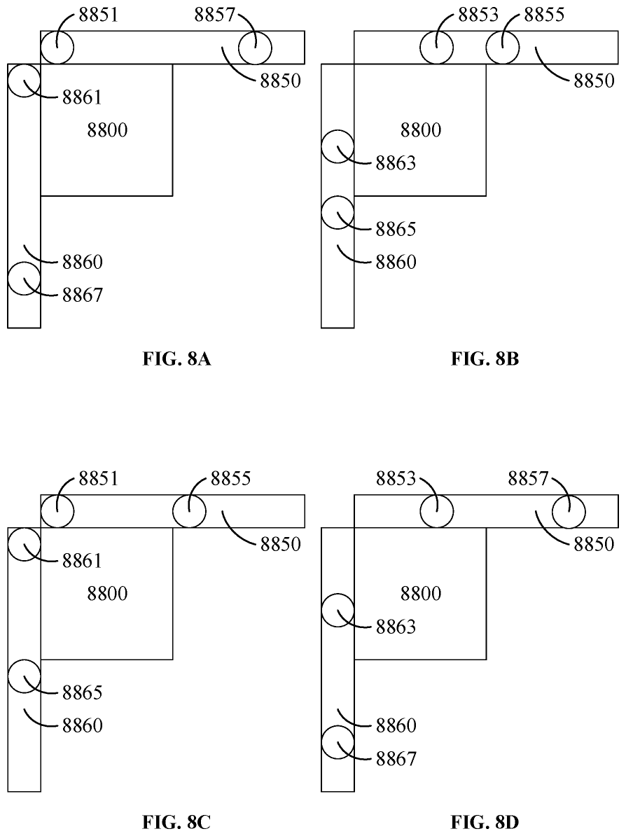

FIGS. 8A-8D are schematic illustrations of example implementations of chroma block unit 8800 and four different sample sets included in the common reference region. In FIG. 8A, a first one of the four sample sets may include the chroma candidate samples 8851, 8857, 8861, and 8867 selected from the common reference region including the chroma neighboring region 8850 and 8860. In FIG. 8B, a second one of the four sample sets may include the chroma candidate samples 8853, 8855, 8863, and 8865 selected from the common reference region including the chroma neighboring region 8850 and 8860. In FIG. 8C, a third one of the four sample sets may include the chroma candidate samples 8851, 8855, 8861, and 8865 selected from the common reference region including the chroma neighboring region 8850 and 8860. In FIG. 8D a fourth one of the four sample sets may include the chroma candidate samples 8853, 8857, 8863, and 8867 selected from the common reference region including the chroma neighboring region 8850 and 8860.

The sample sets may be determined from the common reference region based on a plurality of sampling schemes. Since the sampling schemes may be different from each other, the sample sets may also be different from each other. Each of the linear mode candidates may include a corresponding one of the sampling schemes and a corresponding one of the sample sets and select a plurality of reference samples from the candidate samples in the common reference region to add into the corresponding one of the sample sets based on the corresponding one of the sampling schemes.

The linear model prediction mode may be selected from the linear mode candidates. The selected linear mode candidate may have a corresponding one of the sample sets and a corresponding one of the sampling schemes. Thus, the decoder module 124 may determine the corresponding one of the sampling schemes based on the selected linear mode candidate and further determine the corresponding one of the sample sets from the common reference region based on the corresponding one of the sampling schemes.

The decoder module 124 may select all of the luma down-sampled samples and chroma candidate samples included in the common reference region as a plurality of reference samples for deriving the linear model formula by a sampling scheme. In another implementation, the decoder module 124 may select a part of the luma down-sampled samples and chroma candidate samples included in the common reference region based on the other one of the sampling schemes as the reference samples for deriving the linear model formula. The sampling method may include but is not limited to the sampling schemes provided in the present disclosure.

Each of the sampling schemes may include a starting parameter and an interval parameter. The starting parameter may indicate a first one of the reference samples selected from one of the neighboring regions included in the common reference region. For example, the starting parameter in FIG. 8A and FIG. 8C may be equal to one and the starting parameter in FIG. 8B and FIG. 8D may be equal to three. In addition, the interval parameter may indicate a distance between the first one and a next one of the reference samples selected from the one of the neighboring regions. For example, the interval parameter in FIG. 8A may be equal to six, the interval parameter in FIG. 8B may be equal to two, and the interval parameter in FIG. 8C and FIG. 8D may be equal to four.

The starting parameter and the interval parameter of one of the neighboring regions may be determined based on the number of the candidate samples included in the one of the neighboring regions. For example, the starting parameter and the interval parameter of the chroma neighboring region 8850 may be determined based on the number of the candidate samples included in the chroma neighboring region 8850. In addition, the starting parameter and the interval parameter of the chroma neighboring region 8860 may be determined based on the number of the candidate samples included in the chroma neighboring region 8860.

Table 1 schematically shows some exemplary implementations of the sampling schemes.

TABLE 1

| Linear Mode | Sampling Scheme | |
|---|---|---|
| Candidates | Starting Parameter | Interval Parameter |
| Candidate 1 | numRefSamp >> 3 | (numRefSamp >> 2) + |
| | | ((numRefSamp >> 2) << 1) |
| Candidate 2 | (numRefSamp >> 3) + | numRefSamp >> 2 |
| | ((numRefSamp >> 3) << 1) | |
| Candidate 3 | numRefSamp >> 3 | numRefSamp >> 1 |
| Candidate 4 | (numRefSamp >> 3) + | numRefSamp >> 1 |
| | ((numRefSamp >> 3) << 1) | |

wherein numRefSamp represents the number of the candidate samples included in the one of the neighboring regions. Also, throughout this disclosure, the “x>>y” operator represents an arithmetic right shift of a two's complement integer representation of x by y binary digits, and the “x<<y” operator represents an arithmetic left shift of a two's complement integer representation of x by y binary digits. This function is defined only for non-negative integer values of y. Bits shifted into the most significant bits (MSBs) as a result of the right shift have a value equal to the MSB of x prior to the shift operation, and bits shifted into the least significant bits (LSBs) as a result of the left shift have a value equal to 0.

The block unit may be reconstructed based on two linear model formulas when the linear model prediction mode includes two of the plurality of linear mode candidates. A first one of the two of the linear mode candidates may derive a first one of the two linear model formulas based on a first one of the sample sets determined from the common reference region. The first one of the sample sets may include a first plurality of reference samples selected from the common reference region for the first one of the two linear mode candidates based on a first sampling scheme. In addition, a second one of the two of the linear mode candidates may derive a second one of the two linear model formulas based on a second one of the sample sets determined from the common reference region. The second one of the sample sets may include a second plurality of reference samples selected from the common reference region for the second one of the two linear mode candidates based on a second sampling scheme.

In one implementation, in order to prevent from selecting the same reference sample, the first sampling scheme may be totally different from the second sampling scheme. Thus, each of the first plurality of reference samples may be different from the second plurality of reference samples, although the two of the plurality of linear mode candidates have the common reference region. For example, the first sampling scheme may include a first starting parameter indicating a first reference sample having a maximum luma value and the second sampling scheme may include a second starting parameter indicating another first reference sample having a minimum luma value. In addition, the interval parameter of the first sampling scheme and the second sampling may be determined based on an average of a plurality of luma values of the luma down-sampled samples. In the implementation, each of the interval parameters may indicate the number of the candidate samples having the luma values between the average and the luma value of the corresponding first reference sample.

In another implementation, the first sampling scheme may include a first starting parameter and a first interval parameter and the second sampling scheme may include a second starting parameter and a second interval parameter. The first interval parameter may be different from the second interval parameter when the first starting parameter is identical to the second starting parameter. In addition, the first starting parameter may be different from the second starting parameter when the first interval parameter is identical to the second interval parameter. Thus, the first one of the sample sets may be different from the second one of the sample sets since at least one of the first plurality of reference samples is different from the second plurality of reference samples.

Returning to FIG. 6, at block 640, the decoder module 124 reconstructs the block unit based on the linear model prediction mode.

With reference to FIG. 1, FIG. 7A, and FIG. 7B, the decoder module 124 may derive at least one linear model formula for the block unit by the reference samples included in the common reference region. The luma down-sampled components may be generated by down-sampling a plurality of luma reconstructed components in the luma block unit 7700. The chroma predicted components may be generated based on the luma down-sampled components according to the at least one linear model formula since the luma reconstructed components are reconstructed prior to generating the chroma predicted components.

The decoder module 124 may derive a predicted parameter α and a constant parameter based on the reference samples for each of the at least one linear model formula when the decoder module 124 may generate the chroma predicted components of the chroma block unit 7800 based on the luma down-sampled components of the luma block unit 7700. The decoder module 124 may estimate the predicted parameter α and the constant parameter based on the reference samples for each of the at least one linear model formula via a statistical method. In at least one implementation, the statistical method may be a linear regression analysis.

The decoder module 124 may derive one linear mode formula based on the reference samples when the linear model prediction mode includes only one of the linear mode candidates. Thus, the decoder module 124 may generate one predicted parameter α and one constant parameter β based on the reference samples.

The decoder module 124 may derive two linear mode formulas respectively based on the first plurality of reference samples and the second plurality of reference samples when the linear model prediction mode includes two of the linear mode candidates. Thus, the decoder module 124 may generate two predicted parameters α1 and α2 and two constant parameters β1 and β2 respectively based on the first plurality of reference samples and the second plurality of reference samples.

The chroma predicted components may be generated based on the luma down-sampled components according to the at least one linear model formula, since the luma down-sampled components are reconstructed prior to generating the chroma predicted components. The decoder module 124 may directly down-sample the luma reconstructed components of the luma block unit to generate the luma down-sampled samples and then determine the chroma predicted components based on the luma down-sampled components according to the at least one linear model formula.

The chroma block unit may include a plurality of chroma block elements. In the implementation, each of the chroma block elements may be a chroma pixel element. The decoder module 124 may generate one of the chroma predicted components for each of the block elements. In at least one implementation, the summer 2224 of the decoder module 124 in the second electronic device 120 may add the chroma predicted components into a plurality of chroma residual samples determined from the bitstream to reconstruct the chroma block unit of the block unit. In addition, the decoder module 124 may reconstruct all of the other block units in the image frame for reconstructing the image frame and the video.

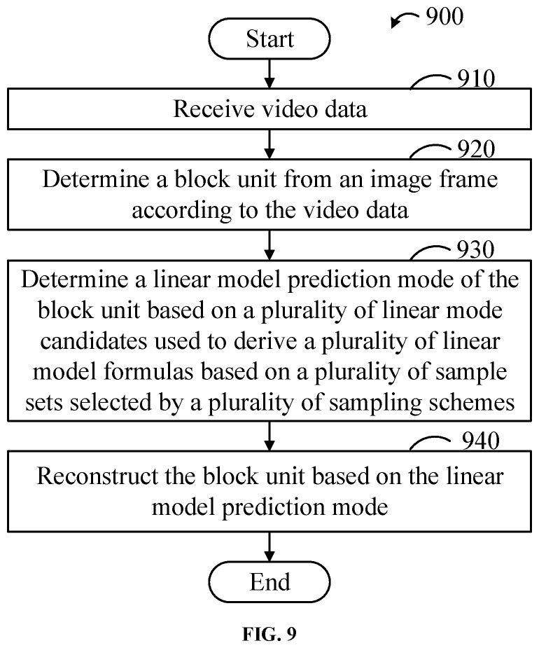

FIG. 9 illustrates a flowchart of a method 900 for decoding video data by an electronic device according to an implementation of the present disclosure. The method 900 is an example only, as there are a variety of ways to perform decoding of the video data.

The method 900 may be performed using the configurations illustrated in FIG. 1 and FIG. 2, and various elements of these figures are referenced with regard to the method 900. Each block illustrated in FIG. 9 may represent one or more processes, methods, or subroutines performed.

The order of blocks in FIG. 9 is illustrative only and may change. Additional blocks may be added or fewer blocks may be utilized without departing from the present disclosure.

At block 910, the decoder module 124 receives video data. The video data received by the decoder module 124 may be a bitstream.

With reference to FIG. 1 and FIG. 2, the second electronic device 120 may receive the bitstream from an encoder, such as the first electronic device 110, or other video providers via the second interface 126. The second interface 126 may provide the bitstream to the decoder module 124.

The entropy decoding unit 2241 may decode the bitstream to determine a plurality of prediction indications and a plurality of partitioning indications for a plurality of image frames. Then, the decoder module 124 may further reconstruct the plurality of image frames based on the prediction indications and the partitioning indications. The prediction indications and the partitioning indications may include a plurality of flags and a plurality of indices.

At block 920, the decoder module 124 determines a block unit from an image frame according to the video data.

With reference to FIG. 1 and FIG. 2, the decoder module 124 may determine the image frame based on the bitstream and divide the image frame to determine the block unit according to the partition indications in the bitstream. For example, the decoder module 124 may divide the image frames to generate a plurality of CTUs, and further divide one of the CTUs to determine the block unit according to the partition indications based on any video coding standard.

Continuing with FIG. 9, at block 930, the decoder module 124 determines a linear model prediction mode of the block unit based on a plurality of linear mode candidates used to derive a plurality of linear model formulas based on a plurality of sample sets selected by a plurality of sampling schemes.

With reference to FIG. 1 and FIG. 2, the linear mode candidates may be used to derive a plurality of linear model formulas based on a CCLM prediction mode and/or a MDLM prediction mode. The decoder module 124 may use the linear model prediction mode to derive one linear model formula to predict the block unit when the linear model formula of the linear model prediction mode is derived based on the CCLM prediction mode or the MDLM prediction mode. The decoder module 124 may determine the linear model prediction mode of the block unit via a mode index included in the bitstream.

A part of the linear mode candidates may correspond to identical reference regions or different reference regions. For example, with reference to FIG. 4A, FIG. 4B and FIGS. 5A-5C, a first part of the linear mode candidates may correspond to a first reference region identical to the reference region shown in FIG. 4A and FIG. 4B, a second part of the linear mode candidates may correspond to a second reference region identical to the reference region shown in FIG. 5A, a third part of the linear mode candidates may correspond to a third reference region identical to the reference region shown in FIG. 5B, and a fourth part of the linear mode candidates may correspond to a fourth reference region identical to the reference region shown in FIG. 5C.

A part of the linear mode candidates may correspond to identical sampling schemes or different sampling schemes. For example, with reference to FIGS. 8A-8D, a fifth part of the linear mode candidates may correspond to a first sampling scheme identical to the sampling scheme of the linear mode candidate in FIG. 8A, a sixth part of the linear mode candidates may correspond to a second sampling scheme identical to the sampling scheme of the linear mode candidate in FIG. 8B, a seventh part of the linear mode candidates may correspond to a third sampling scheme identical to the sampling scheme of the linear mode candidate in FIG. 8C, and a eighth part of the linear mode candidates may correspond to a fourth sampling scheme identical to the sampling scheme of the linear mode candidate in FIG. 8D.

Table 2 schematically shows some exemplary implementations of the sampling schemes.

TABLE 2

| Linear Mode | Reference | Sampling Scheme | |
|---|---|---|---|
| Candidates | Region | Starting Parameter | Interval Parameter |
| Candidate 1 | Above, Left, | numRefSamp >> 3 | (numRefSamp >> |
| | Above-Right, | | 2) + |
| | Bottom-Left | | ((numRefSamp >> |
| | | | 2) << 1) |
| Candidate 2 | Above, Left, | (numRefSamp >> | numRefSamp >> 2 |
| | Above-Right | 3) + | |
| | | ((numRefSamp >> | |
| | | 3) << 1) | |
| Candidate 3 | Above, Left, | numRefSamp >> 3 | numRefSamp >> 1 |
| | Bottom-Left | | |

wherein numRefSamp represents the number of the candidate samples included in the one of the neighboring regions.

Returning to FIG. 9, at block 940, the decoder module 124 reconstructs the block unit based on the linear model prediction mode.

With reference to FIG. 1 and FIG. 2, the decoder module 124 may derive at least one linear model formula for the block unit by the reference samples included in the common reference region. The luma down-sampled components may be generated by down-sampling a plurality of luma reconstructed components in the luma block unit. The chroma predicted components may be generated based on the luma down-sampled components according to the at least one linear model formula, since the luma reconstructed components are reconstructed prior to generating the chroma predicted components.

The decoder module 124 may derive a predicted parameter α and a constant parameter β based on the reference samples for each of the at least one linear model formula when the decoder module 124 may generate the chroma predicted components of the chroma block unit 7800 based on the luma down-sampled components of the luma block unit. The decoder module 124 may estimate the predicted parameter α and the constant parameter β based on the reference samples for each of the at least one linear model formula via a statistical method. In at least one implementation, the statistical method may be a linear regression analysis.

The chroma predicted components may be generated based on the luma down-sampled components according to the at least one linear model formula since the luma down-sampled components are reconstructed prior to generating the chroma predicted components. The decoder module 124 may directly down-sample the luma reconstructed components of the luma block unit to generate the luma down-sampled samples and then determine the chroma predicted components based on the luma down-sampled components according to the at least one linear model formula.

The chroma block unit may include a plurality of chroma block elements. In the implementation, each of the chroma block elements may be a chroma pixel element. The decoder module 124 may generate one of the chroma predicted components for each of the block elements. In at least one implementation, the summer 2224 of the decoder module 124 in the second electronic device 120 may add the chroma predicted components into a plurality of chroma residual samples determined from the bitstream to reconstruct the chroma block unit of the block unit. In addition, the decoder module 124 may reconstruct all of the other block units in the image frame for reconstructing the image frame and the video.

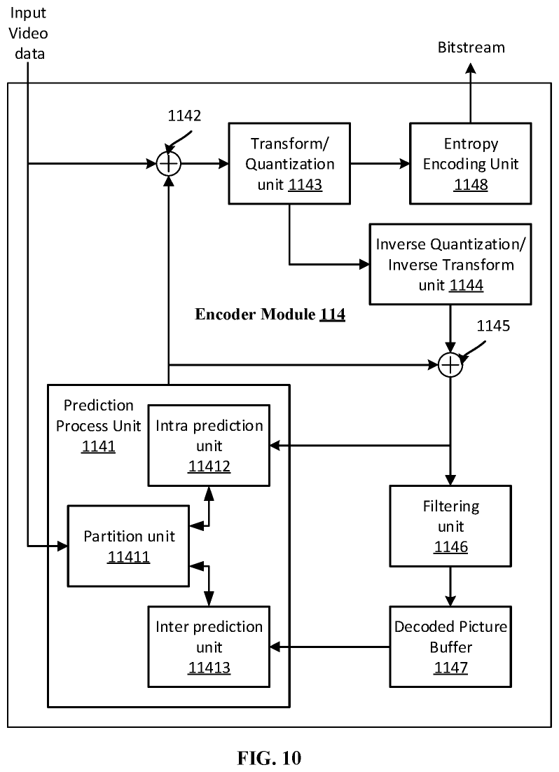

FIG. 10 illustrates a block diagram of the encoder module 114 of the first electronic device 110 illustrated in FIG. 1 according to an implementation of the present disclosure. The encoder module 114 may include a prediction processor (e.g., prediction process unit 1141), at least a first summer (e.g., first summer 1142) and a second summer (e.g., second summer 1145), a transform/quantization processor (e.g., transform/quantization unit 1143), an inverse quantization/inverse transform processor (e.g., inverse quantization/inverse transform unit 1144), a filter (e.g., filtering unit 1146), a decoded picture buffer (e.g., decoded picture buffer 1147), and an entropy encoder (e.g., entropy encoding unit 1148). The prediction process unit 1141 of the encoder module 114 may further include a partition processor (e.g., partition unit 11411), an intra prediction processor (e.g., intra prediction unit 11412), and an inter prediction processor (e.g., inter prediction unit 11413).

The encoder module 114 may receive the source video and encode the source video to output a bitstream. The encoder module 114 may receive source video including a plurality of image frames and then divide the image frames according to a coding structure. Each of the image frames may be divided into at least one image block.

The at least one image block may include a luminance block having a plurality of luminance samples and at least one chrominance block having a plurality of chrominance samples. The luminance block and the at least one chrominance block may be further divided to generate macroblocks, coding tree units (CTUs), coding blocks (CBs), sub-divisions thereof, and/or another equivalent coding unit.

The encoder module 114 may perform additional sub-divisions of the source video. It should be noted that the disclosed implementations are generally applicable to video coding regardless of how the source video is partitioned prior to and/or during the encoding.

During the encoding process, the prediction process unit 1141 may receive a current image block of a specific one of the image frames. The current image block may be the luminance block or one of the chrominance blocks in the specific image frame.

The partition unit 11411 may divide the current image block into multiple block units. The intra prediction unit 11412 may perform intra-predictive coding of a current block unit relative to one or more neighboring blocks in the same frame as the current block unit in order to provide spatial prediction. The inter prediction unit 11413 may perform inter-predictive coding of the current block unit relative to one or more blocks in one or more reference image blocks to provide temporal prediction.

The prediction process unit 1141 may select one of the coding results generated by the intra prediction unit 11412 and the inter prediction unit 11413 based on a mode selection method, such as a cost function. The mode selection method may be a rate-distortion optimization (RDO) process.

The prediction process unit 1141 may determine the selected coding result and provide a predicted block corresponding to the selected coding result to the first summer 1142 for generating a residual block and to the second summer 1145 for reconstructing the encoded block unit. The prediction process unit 1141 may further provide syntax elements, such as motion vectors, intra mode indicators, partition information, and other syntax information, to the entropy encoding unit 1148.

The intra prediction unit 11412 may intra predict the current block unit. The intra prediction unit 11412 may determine an intra prediction mode directed toward a reconstructed sample neighboring the current block unit in order to encode the current block unit.

The intra prediction unit 11412 may encode the current block unit using various intra prediction modes. The intra prediction unit 11412 of the prediction process unit 1141 may select an appropriate intra prediction mode from the selected modes. The intra prediction unit 11412 may encode the current block unit using a cross component prediction mode to predict one of the two chroma components of the current block unit based on the luma components of the current block unit. The intra prediction unit 11412 may predict a first one of the two chroma components of the current block unit based on the second of the two chroma components of the current block unit.

The inter prediction unit 11413 may inter predict the current block unit as an alternative to the intra prediction performed by the intra prediction unit 11412. The inter prediction unit 11413 may perform motion estimation to estimate motion of the current block unit for generating a motion vector.

The motion vector may indicate a displacement of the current block unit within the current image block relative to a reference block unit within a reference image block. The inter prediction unit 11413 may receive at least one reference image block stored in the decoded picture buffer 1147 and estimate the motion based on the received reference image blocks to generate the motion vector.

The first summer 1142 may generate the residual block by subtracting the prediction block determined by the prediction process unit 1141 from the original current block unit. The first summer 1142 may represent the component or components that perform this subtraction.

The transform/quantization unit 1143 may apply a transform to the residual block in order to generate a residual transform coefficient and then quantize the residual transform coefficients to further reduce bit rate. The transform may be one of a DCT, DST, AMT, MDNSST, HyGT, signal dependent transform, KLT, wavelet transform, integer transform, sub-band transform, or a conceptually similar transform.

The transform may convert the residual information from a pixel value domain to a transform domain, such as a frequency domain. The degree of quantization may be modified by adjusting a quantization parameter.

The transform/quantization unit 1143 may perform a scan of the matrix including the quantized transform coefficients. Alternatively, the entropy encoding unit 1148 may perform the scan.

The entropy encoding unit 1148 may receive a plurality of syntax elements from the prediction process unit 1141 and the transform/quantization unit 1143 including a quantization parameter, transform data, motion vectors, intra modes, partition information, and other syntax information. The entropy encoding unit 1148 may encode the syntax elements into the bitstream.

The entropy encoding unit 1148 may entropy encode the quantized transform coefficients by performing CAVLC, CABAC, SBAC, PIPE coding, or another entropy coding technique to generate an encoded bitstream. The encoded bitstream may be transmitted to another device (i.e., the second electronic device 120 in FIG. 1) or archived for later transmission or retrieval.

The inverse quantization/inverse transform unit 1144 may apply inverse quantization and inverse transformation to reconstruct the residual block in the pixel domain for later use as a reference block. The second summer 1145 may add the reconstructed residual block to the prediction block provided from the prediction process unit 1141 in order to produce a reconstructed block for storage in the decoded picture buffer 1147.

The filtering unit 1146 may include a deblocking filter, an SAO filter, a bilateral filter, and/or an ALF to remove blocking artifacts from the reconstructed block. Additional filters (in loop or post loop) may be used in addition to the deblocking filter, the SAO filter, the bilateral filter, and the ALF. Such filters are not illustrated for brevity and may filter the output of the second summer 1145.

The decoded picture buffer 1147 may be a reference picture memory that stores the reference block for use by the encoder module 114 to encode video, such as in intra or inter coding modes. The decoded picture buffer 1147 may include a variety of memory devices such as DRAM (e.g., including SDRAM), MRAM, RRAM, or other types of memory devices. The decoded picture buffer 1147 may be on-chip with other components of the encoder module 114 or off-chip relative to those components.

The encoder module 114 may receive video data and use a plurality of prediction candidate modes to predict a plurality of image frames in the video data. The prediction candidate modes may include a plurality of linear mode candidates in one of the methods 300, 600, and 900. The encoder module 114 may signal, based on the prediction results, a mode index for each of the block units in the video data for indicating a prediction mode of the block unit.

When the prediction mode is one of the linear mode candidates in one of the methods 300, 600, and 900, the encoder module 114 may determine the prediction mode based on the linear mode candidates in one of the methods 300, 600, and 900, and determine at least one linear model formula to predict the block unit for generating a plurality of chroma predicted components.

The block unit in the video data may include a plurality of pixel elements having a plurality of luma pixel components and a plurality of chroma pixel components. The encoder module 114 predicts the block unit to generate a plurality of chroma residual samples by subtracting the chroma predicted components from the chroma pixel component and provide the bitstream including a plurality of coefficients corresponding to the chroma residual samples.

The encoder module 114 may receive video data and use a plurality of prediction modes to predict a plurality of image frames in the video data. In the implementation, the video data may be a video and the prediction modes may be indicated by a plurality of flags and a plurality of indices.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A method of decoding a bitstream by an electronic device, the method comprising:
receiving the bitstream;
determining a block unit from an image frame according to the bitstream;
determining a linear model prediction mode of the block unit based on a plurality of linear mode candidates, the plurality of linear mode candidates being used to derive a plurality of linear model formulas based on a plurality of sample sets determined from a common reference region; and
reconstructing the block unit based on the linear model prediction mode.

2. The method according to claim 1, wherein:
the plurality of sample sets is determined from the common reference region based on a plurality of sampling schemes;
the sample sets in the plurality of sample sets are different from each other; and
the sampling schemes in the plurality of sampling schemes are different from each other.

3. The method according to claim 2, wherein:
the common reference region includes a plurality of candidate samples;
a specific one of the plurality of linear mode candidates selects a plurality of reference samples from the plurality of candidate samples into a specific one of the plurality of sample sets based on a specific one of a plurality of sampling schemes; and
the specific one of the plurality of sample sets and the specific one of the plurality of sampling schemes correspond to the specific one of the plurality of linear mode candidates.

4. The method according to claim 2, wherein:
each of the plurality of sampling schemes includes a starting parameter and an interval parameter.

5. The method according to claim 1, wherein:
the linear model prediction mode includes two of the plurality of linear mode candidates; and
the block unit is reconstructed based on the two of the plurality of linear mode candidates.

6. The method according to claim 5, wherein:
a first one of the two of the plurality of linear mode candidates derives a first one of the plurality of linear model formulas based on a first one of the plurality of sample sets determined from the common reference region; and
a second one of the two of the plurality of linear mode candidates derives a second one of the plurality of linear model formulas based on a second one of the plurality of sample sets determined from the common reference region.

7. The method according to claim 5, wherein:
a first plurality of reference samples is selected from the common reference region for a first one of the two of the plurality of linear mode candidates based on a first sampling scheme; and
a second plurality of reference samples is selected from the common reference region for a second one of the two of the plurality of linear mode candidates based on a second sampling scheme.

8. The method according to claim 7, wherein:
the first sampling scheme includes a first starting parameter and a first interval parameter;
the second sampling scheme includes a second starting parameter and a second interval parameter;
the first interval parameter is different from the second interval parameter when the first starting parameter is identical to the second starting parameter; and
the first starting parameter is different from the second starting parameter when the first interval parameter is identical to the second interval parameter.

9. The method according to claim 7, wherein each of the first plurality of reference samples is different from each of the second plurality of reference samples.

10. An electronic device for decoding a bitstream, the electronic device comprising:
at least one processor; and
a storage device coupled to the at least one processor and storing a plurality of instructions which, when executed by the at least one processor, causes the electronic device to:
determine a block unit from an image frame according to the bitstream;
determine a linear model prediction mode of the block unit based on a plurality of linear mode candidates, the plurality of linear mode candidates being used to derive a plurality of linear model formulas based on a plurality of sample sets determined from a common reference region; and
reconstruct the block unit based on the linear model prediction mode.

11. The electronic device according to claim 10, wherein:
the plurality of sample sets is determined from the common reference region based on a plurality of sampling schemes;
the sample sets in the plurality of sample sets are different from each other; and
the sampling schemes in the plurality of sampling schemes are different from each other.

12. The electronic device according to claim 11, wherein:
the common reference region includes a plurality of candidate samples;
a specific one of the plurality of linear mode candidates selects a plurality of reference samples from the plurality of candidate samples into a specific one of the plurality of sample sets based on a specific one of a plurality of sampling schemes; and
the specific one of the plurality of sample sets and the specific one of the plurality of sampling schemes correspond to the specific one of the plurality of linear mode candidates.

13. The electronic device according to claim 10, wherein:
the linear model prediction mode includes two of the plurality of linear mode candidates; and
the block unit is reconstructed based on the two of the plurality of linear mode candidates.

14. The electronic device according to claim 13, wherein:
a first plurality of reference samples is selected from the common reference region for a first one of the two of the plurality of linear mode candidates based on a first sampling scheme; and
a second plurality of reference samples is selected from the common reference region for a second one of the two of the plurality of linear mode candidates based on a second sampling scheme.

15. The electronic device according to claim 14, wherein each of the first plurality of reference samples is different from each of the second plurality of reference samples.

16. A method of decoding a bitstream by an electronic device, the method comprising:
receiving the bitstream;
determining a block unit from an image frame according to the bitstream;
determining a linear model prediction mode of the block unit based on a plurality of linear mode candidates having a common reference region, wherein:
the plurality of linear mode candidates is used to derive a plurality of linear model formulas based on the common reference region, and
the linear model formulas in the plurality of linear model formulas are different from each other; and
reconstructing the block unit based on the linear model prediction mode.

17. The method according to claim 16, wherein:
each of the plurality of linear mode candidates corresponds to one of a plurality of sample sets;
the plurality of sample sets is determined from the common reference region based on a plurality of sampling schemes;
the sample sets in the plurality of sample sets are different from each other; and
the sampling schemes in the plurality of sampling schemes are different from each other.

18. The method according to claim 17, wherein:
the common reference region includes a plurality of candidate samples;
a specific one of the plurality of linear mode candidates selects a plurality of reference samples from the plurality of candidate samples into a specific one of the plurality of sample sets based on a specific one of a plurality of sampling schemes; and
the specific one of the plurality of sample sets and the specific one of the plurality of sampling schemes correspond to the specific one of the plurality of linear mode candidates.

19. The method according to claim 16, wherein:
the linear model prediction mode includes two of the plurality of linear mode candidates; and
the block unit is reconstructed based on the two of the plurality of linear mode candidates.

20. The method according to claim 19, wherein:
a first plurality of reference samples is selected from the common reference region for a first one of the two of the plurality of linear mode candidates based on a first sampling scheme; and
a second plurality of reference samples is different from the first plurality of reference samples and selected from the common reference region for a second one of the two of the plurality of linear mode candidates based on a second sampling scheme.
